(19) United States
(12) Patent Application Publication
(10) Pub. No.: US 2010/0156663 A1
(43) Pub. Date: Jun. 24, 2010

(54) RADIOSONDE HAVING HYDROPHOBIC FILTER COMPRISING HUMIDITY SENSOR

(75) Inventors: RAMKRISHNA PAL, BANGALORE (IN); GARFIELD Joseph LOWE, BANGALORE (IN)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., PHOENIX, AZ (US)

(21) Appl. No.: 12/340,517

(22) Filed: Dec. 19, 2008

(51) Int. Cl. G01W 1/08; G08C 17/00; G01N 19/10

(52) U.S. Cl. 340/870.1; 73/335.04

(57) ABSTRACT

Radiosondes (200) and related radiosonde systems (500) include a plurality of different sensors (105, 218, 237, 239) for acquiring sensor data related to atmospheric data, wherein the plurality of sensors consist of a single humidity sensor (105) that is within a sealed housing (120). The sealed housing (120) includes a hydrophobic filter window (130) that allows in ambient gases while preventing entry of condensed forms of moisture from entering the sealed housing (120). A wireless transmitter (255) including an antenna (228) is coupled to an output of the plurality of sensors (100, 218, 237, 239) for transmission of the sensor data over a wireless path to at least one ground based receiver. The radiosonde (200) is generally exclusive of any heater.

### FIELD OF THE INVENTION

The present invention relates to radiosondes and radiosonde comprising systems that include at least one humidity sensor.

### BACKGROUND

Radiosondes are small expendable packaged systems that include sensors for obtaining atmospheric data and a radio transmitter for transmitting the atmospheric data. The radiosonde is generally tethered to a hydrogen or helium filled balloon and launched into the upper atmosphere to collect the atmospheric data. The radiosonde includes a battery to provide power to the radiosonde components. The atmospheric data is in analog form and is transmitted over the air to remotely located data collection locations, which are generally fixed locations. Radiosondes generally measure atmospheric parameters including temperature, air pressure, wind speed, relative humidity, and in some applications the ozone level.

Weather services all over the world simultaneously launch radiosondes in order to form a measurement grid of the upper atmosphere. These launches typically occur twice daily at twelve-hour intervals. As known in the art, the temperature in the upper atmosphere is generally significantly lower as compared to ground level. The low temperature is known to result in frost/condensing conditions in which water vapor in the air can freeze or condenses into liquid form. Frost or condensation is known to lead to significant measurement error, particularly for humidity sensors.

In response to known frost and condensation induced problems, conventional radiosondes include a first and a second humidity sensor as well as a heater. In operation, while the first humidity sensor is being heated to remove accumulated frost or condensation, the second humidity sensor is used for the humidity measurements that are reported. After a short period of time, such as a few minutes, using a switching circuit, the second first humidity sensor is heated to remove accumulated frost or condensation, while the first humidity sensor is then used for humidity measurements. This switching is repeated during the flight.

Conventional radiosondes generally report accurate humidity data. However, conventional radiosonde arrangements require significant electrical power from a power source such as a battery to provide power for operation of the heater. The heater is known to significantly increase the overall power consumption, such as by 100% or more. The need for a second humidity sensor as well as the heater also increases the weight of the radiosonde. Moreover, the added components increase complexity which can reduce the reliability of the radiosonde.

### SUMMARY

This Summary is provided to comply with 37 C.F.R. §1.73, presenting a summary of the invention to briefly indicate the nature and substance of the invention. It is submitted with the understanding that it will not be used to interpret or limit the scope or meaning of the claims.

Embodiments of the invention provide radiosondes that comprise a plurality of different sensors for acquiring sensor data related to atmospheric data, wherein the plurality of sensors consist of a single humidity sensor. The single humidity sensor is within a sealed housing. The sealed housing includes a hydrophobic filter window that allows in ambient gases while preventing entry of condensed forms of moisture from entering the sealed housing. A wireless transmitter is coupled to the respective outputs from the plurality of sensors for transmission of the sensor data over a wireless path to at least one ground based receiver

Radiosondes according to embodiments of the invention do not require a heater for the humidity sensor which as noted in the background requires significant additional electrical power (e.g., a larger, heavier and more expensive battery) to be supplied to the radiosonde to provide power for the heater. Radiosondes according to embodiments of the invention being operable with a single humidity sensor also eliminate the need for a second humidity sensor that is required by conventional radiosondes. Moreover, by eliminating the need for a heater and second humidity sensor, radiosondes according to embodiments of the invention reduce system complexity and thus improve the reliability of the radiosonde.

### BRIEF DESCRIPTION OF THE DRAWINGS

FIG. 1 is a depiction of an integrated condensed phase resistant humidity sensor system including a sealed housing having a window comprising a porous hydrophobic material for selectively passing atmospheric gasses including water vapor into the housing to reach the humidity sensor while rejecting condensed phases, according to an embodiment of the invention.

FIG. 2 is high level block diagram for a radiosonde comprising a controller module and a relative humidity sensing module, according to another embodiment of the invention.

FIG. 3 is a functional block diagram for radiosonde shown in FIG. 2 showing additional exemplary details for the humidity sensing module and the controller module, according to an embodiment of the invention.

FIG. 4 is depiction of an exemplary PCB layout for some of the components for a radiosonde according to an embodiment of the invention.

FIG. 5 shows a radiosonde system comprising the radiosonde shown in FIG. 4 tethered by a rope/cord to a hydrogen or helium filled balloon depicted during service in the upper atmosphere to collect atmospheric data.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the invention describe radiosonde and radiosonde systems that comprise a plurality of different sensors for acquiring sensor data related to atmospheric data. In contrast to conventional radiosondes which require two (2) humidity sensors, the plurality of sensors consist of a single humidity sensor. The single humidity sensor is positioned within a sealed housing. The sealed housing includes a hydrophobic filter window that allows in ambient gases while preventing entry of condensed forms including water droplets and frost from entering the sealed housing. A wireless transmitter including an antenna is coupled to an output of the plurality of sensors for transmission of the sensor data over a wireless path to at least one ground based receiver.

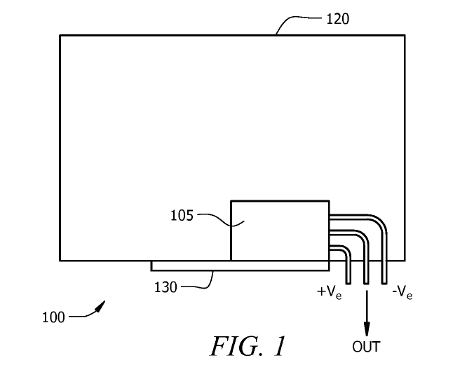

FIG. 1 is a depiction of an integrated condensed phase resistant humidity sensor system 100, according to an embodiment of the invention. Humidity sensing system 100 comprises a sealed housing/package 120 having a filter window 130 that comprises a porous hydrophobic material and a humidity sensor 105 positioned therein. Filter window 130 selectively passes atmospheric gases including water vapor into the housing/package 120 to reach the humidity sensor 105, but resists entry of frost and other condensed phases including dust, dirt, water, and oil. Housing/package 120 is generally formed from a polymeric material such as a thermoset polymer that provides a complete seal so that environmental gases can only reach the humidity sensor 105 through the filter window 130. Although only one filter window 130 is shown, humidity sensing system 100 can include a plurality of filter windows.

Humidity sensor 105 can generally comprise a capacitive, resistive, or thermal conductivity-based humidity sensor. In one embodiment, humidity sensor 105 is an integrated circuit-based capacitive humidity sensor. As known in the art, the structure of integrated circuit-based capacitive humidity sensors generally include interdigitated electrodes and a humidity sensitive dielectric sensing film. The humidity sensitive dielectric sensing film, such as a polyimide, is coated on the interdigitated electrodes. The humidity sensor changes in its capacitance when the sensing film absorbs or desorbs water vapor. The change in capacitance can be sensed in a number of ways, such as based on the shift in resonant frequency of a resonant circuit (not shown).

The three (3) leads shown emerging from the housing/housing 120 can comprise a pair of power supply leads (e.g., −ve and +ve) for powering humidity sensor 100 (e.g., a 5 volt differential) from a suitable power source (not shown) and the output from humidity sensor 105. Although not shown, the humidity sensing system 100 can further comprise on-chip integrated signal conditioning circuitry therein coupled to the humidity sensor 105 so that the output of the humidity sensing system 100 is a conditioned output. Signal conditioning circuitry can include filtering and amplification circuitry.

In one embodiment, humidity sensing system 100 can be obtained commercially, such as the HIH-4021 humidity sensor from Honeywell Sensing and Controls, a division of Honeywell International Morristown, N.J. The HIH-4021 is an integrated circuit-based laser trimmed, thermoset polymer capacitive element with on-chip signal conditioning and provisional for on-chip resistance temperature detection (RTD)-based temperature sensing. The HIH-4021 has an inbuilt ASIC which provides percent Relative Humidity (RH) outputs in terms of voltage. The on-chip signal processing ensures linear voltage output versus percent RH.

Prior to the present invention, HIH-4021 had been used exclusively for ground based applications which as known in the art involves much less rigorous conditions as compared to atmospheric conditions in the upper atmosphere. In tests performed by the Present Inventors described in the Examples below that simulated upper atmosphere conditions including a temperature of about −10° C., humidity sensor systems based on HIH-4021 were surprisingly found to provide accurate and reliable humidity data for periods of at least several hours, which is generally long enough for the flight time of conventional radiosondes which as described above is limited to several hours, such as about two (2) hours.

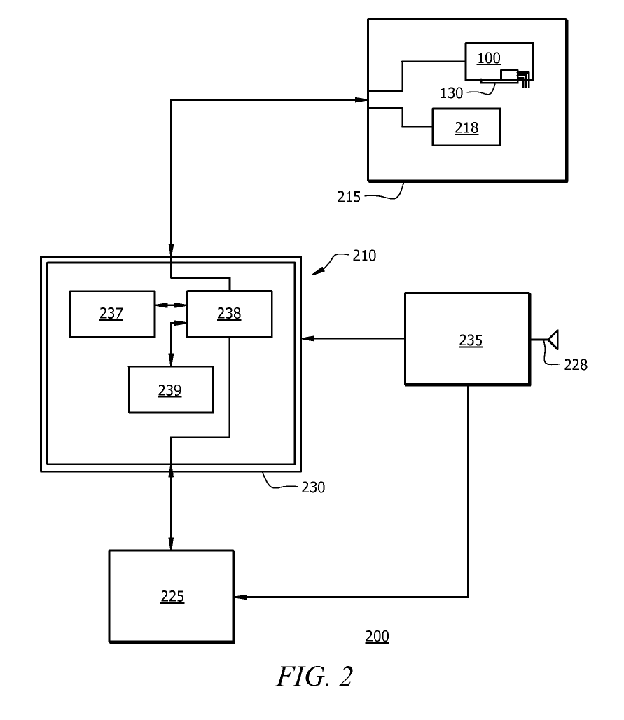

FIG. 2 is high level block diagram for a radiosonde 200 comprising a controller module 210 and a relative humidity sensing module 215, according to another embodiment of the invention. In one embodiment, controller module 210 and relative humidity sensing module 215 are embodied as printed circuit board (PCB) modules. Radiosonde 200 also includes a power supply shown as a wet cell battery 235 and a wireless transmitter module 225 that includes an antenna 228.

Although battery 215 is shown as a wet cell battery, battery 235 can also be a dry-cell battery. However, a wet cell battery or water activated battery provides the helpful features of becoming activated only when dipped inside the water and has the capability to provide high current continuously. Water activated helps in increasing the storage life of the battery. In contrast, dry cells may sometimes stop providing continuous current for couple of second if sourced for more than about 60 minutes.

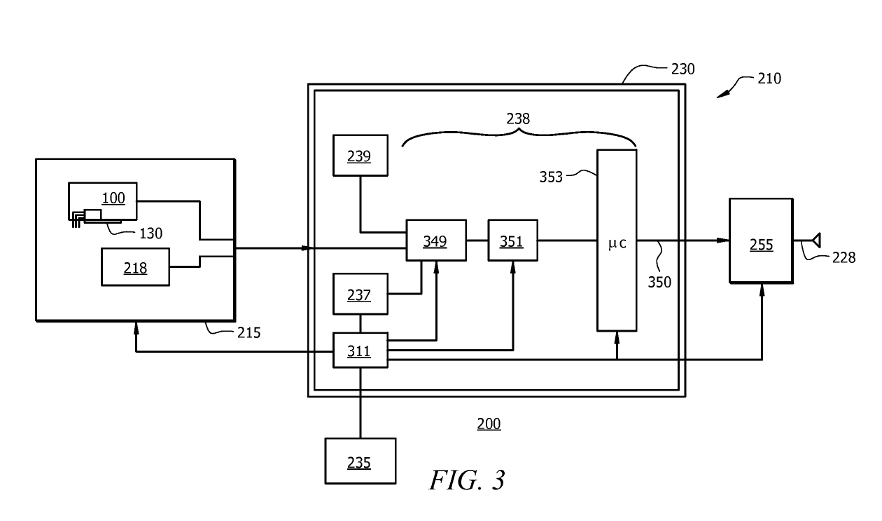

The controller module 210 is shown including an outer housing 230 having a pressure sensor 237, signal conditioning and processing electronics module 238, and (internal) temperature sensor 239 therein for error compensation. The battery 235 is shown coupled to controller module 210, and transmitter module 225. The controller module 210 supplies power to the humidity sensing module 215. Although not shown in FIG. 2 (see FIG. 3), the controller module 210 generally includes power supply conditioning circuitry which provides several built in protections.

The humidity sensing module 215 is shown including a separate temperature sensor 218 for measuring the ambient temperature and a relative humidity (RH) sensor shown as the integrated humidity sensing system 100 shown in FIG. 1. However, in some embodiments of the invention, the humidity sensing system 100 has a provision for mounting temperature sensor, which would remove the need for a stand alone temperature sensor, such as temperature sensor 218 shown in FIG. 2. A separate temperature sensor, such as temperature sensor 218 shown in FIG. 2, allows selection from a wider range of temperature sensors, such as temperature both sensors that provide a small size and fast response time. The size of the temperature sensor 218 can be <0.5 mm in diameter.

FIG. 3 is a functional block diagram for radiosonde 200 shown in FIG. 2 showing additional exemplary details for the humidity sensing module 215 and the controller module 210, according to an embodiment of the invention. As in FIG. 2, the controller module 210 is housed inside a housing 230 which protects the components therein against exposure to the external environment. Controller module 210 is shown including voltage regulator and protection block 311 coupled to the battery 235 that can comprise built in protection circuitry including reverse polarity protection diode, a voltage regulator and over current protection. A pressure sensor 237 is also within housing 230. During flight, the measurement from pressure sensor 237 can be used to derive the altitude of the radiosonde 200. In one embodiment of the invention pressure sensor 237 can comprise a piezoresistive sensor that is temperature compensated using the temperature sensed by temperature sensor 239 by signal conditioning and processing electronics module 238 as described below. Temperature sensor 239 can be mounted close to the pressure sensor 237, such as on a common PCB for the controller module 210.

The signal conditioning and processing electronics module 238 is shown comprising in serial connection filtering circuitry 349, an analog to digital converter (ADC) 351, and microcontroller 353. As known in the art, a microcontroller (sometimes referred to as an MCU or μC) is a functional computer system-on-a-chip. The microcontroller includes a processor core, memory, and programmable input/output peripherals. Microcontrollers typically include an integrated CPU, memory (RAM, program memory, or both) and peripherals capable of input and output. One function of microcontroller 353 is to control sampling of the respective sensors at regular intervals (e.g., every 0.1 seconds to 10 seconds).

The signal conditioning and processing electronics module 238 receives sensor outputs from pressure sensor 237 and temperature sensor 239 and regulated power from the battery 235 via voltage regulator and protection block 311 and outputs one or more conditioned digital output data streams 350. The microcontroller 353 can include firmware and algorithms for compensating for various environmental errors and interdependent physical measuring errors, as well as linearization and scaling, and sensor biasing. Scaling can comprise ensuring the sensor output is consistent within no more than about 4 mV. The firmware and algorithms can be implemented in microcontroller 353 in a slave configuration. In another embodiment, the signal conditioning and processing electronics module 238 is implemented using discrete IC's. In yet another embodiment, the signal conditioning and processing electronics module 238 can be implemented in one or more application specific integrated circuits (ASICs). Signal conditioning and processing electronics module 238 can also include provisions for GPS and serial interface and for interfacing additional sensors (e.g., an ozone sensor).

Signal conditioning and processing electronics module 238 can be used to compensate for various interdependent errors, compensates for inter related environment conditions and cross functional errors apart from offset, such as hysteresis. The compensated digital output 350 is scaled by conditioning module 342 within the required range to provide scaled analog voltage levels in a digital string. The signal conditioning and processing electronics module 238 can also provide control of bias to the temperature sensors 239 and 218 for measuring the resistance change with respect to temperature.

The digital output 350 can be in the form of a synchronous serial data link such as the serial peripheral interface (SPI) output including pressure, RH and temperature data. The digital output is coupled to antenna 228 of the wireless transmitter 255 for transmission to one or more ground receiving stations, such as at the conventional 404 MHz or 1,680 MHz frequencies.

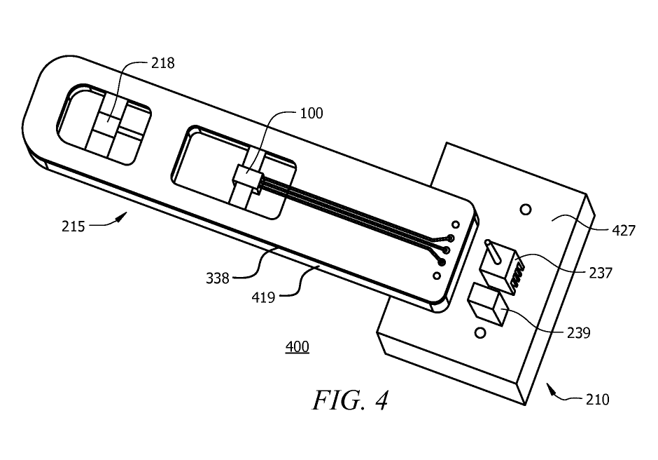

The humidity sensing module 215 generally includes a boom (see FIG. 4 described below) and is generally mounted external to the conditioning module 210 which as noted above includes housing 230. In this arrangement, atmospheric air is in direct contact with humidity sensing module 215. Since humidity sensing system 100 is exposed to the atmosphere for measuring the humidity level, and the temperature can be <0° C., there is a possibility of condensing conditions. As described above, humidity sensing system 100 includes a hydrophobic filter 130 which enables the sensing system 100 to be used in frost/condensing conditions thereby preventing the requirement for radiosonde 200 to include any heating structure.

FIG. 4 is depiction of an exemplary PCB layout for some of the components for a radiosonde 400 according to an embodiment of the invention. Radiosonde 400 is shown including a humidity sensing module 215 including a boom PCB 419 having humidity sensing system 100 and temperature sensor 218 mounted thereon. Controller module 210 includes a controller PCB 427. Housing 230 is not shown in FIG. 4 to reveal pressure sensor 237 and temperature sensor 239. PCB 419 is secured to PCB 427. The surface of PCB 419 is shown including a radiation protection layer 338 on its surface to minimize effects including radiational heating effects. The radiation protection layer 338 is configured for reflecting radiation in the visible, infrared and UV range. The radiation protection layer 338 is generally a dielectric layer. In one embodiment the radiation protection layer 338 comprises a silver colored dielectric coating comprising one or more non-electrically conductive materials which is applied above the traces on the surface of the PCB 419.

An EMI/EMC shield (not shown) can be mounted above the controller PCB 427 and an extension of the EMI/EMC shield can be soldered to the boom PCB 419 to provide added support and protection against radiation transmitted by radiation antenna 228 shown in FIGS. 2 and 3. In one embodiment the material for the EMI/EMC shield can comprise copper, such as 0.3 mm thick copper.

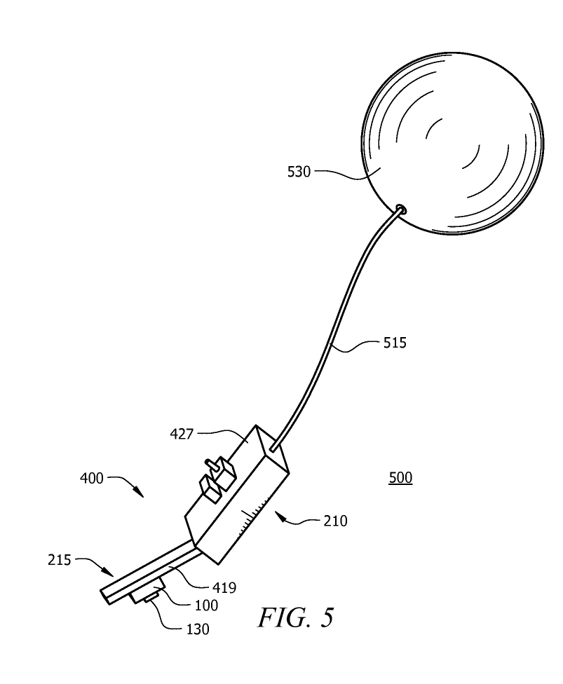

FIG. 5 shows a radiosonde system 500 comprising the radiosonde 400 shown in FIG. 4 tethered by rope/cord 515 to a hydrogen or helium filled balloon 530 depicted during service in the upper atmosphere to collect the atmospheric data. The radiosonde 400 is configured and secured to rope 515 so that hydrophobic filter window 130 of humidity sensing system 100 faces toward the ground. As used herein, “faces toward the ground” refers to being oriented at an angle that is ±60 degrees of a normal to the surface of the underlying terrain directly below the radiosonde 400. Having hydrophobic filter window facing toward the ground can aid in reducing the transmission of condensables through hydrophobic filter window 130, such as by avoiding precipitation (e.g., rain or snow) from contacting hydrophobic filter window 130.

Advantages of embodiments of the invention include a single humidity sensor which is enabled by the porous hydrophobic filter 130 described above. The features of a single humidity sensor and no longer needing a heater results in radiosondes that provide reduced weight and lower power consumption as compared to conventional radiosondes. The digital output provided by the radiosonde provides ease of interface, the ability for transmission error check, and generally improved accuracy compared to conventional radiosondes which provide analog output. The digital outputs provided provide signals with the required physical units (e.g., hPa, ° C., % RH) and as a result, there is generally no signal processing requirement at the receiving ground-based station.

Moreover, radiosondes according to embodiments of the invention generally operate together with any kind of decoder and are thus independent of type of decoder as no calibration is generally required at ground station. This aspect can provide significant cost saving for the decoder at the receiving ground-based station.

### EXAMPLES

The following non-limiting Examples serve to illustrate selected embodiments of the invention. It will be appreciated that variations in proportions and alternatives in elements of the components shown will be apparent to those skilled in the art and are within the scope of embodiments of the present invention.

### Water Spray Tests:

The water spray tests tested the performance of the hydrophobic filter on liquid water ingress for a radiosonde 200. The temperature was fixed at −10° C. and water was sprayed at intervals of five (5) seconds for several minutes to induce condensation. No failures were observed or any detectable change in the output of integrated condensed phase resistant humidity sensor system 100 or any of the other sensors due to the water spray.

### Silver Colored Dielectric Coating Tests

One silver colored dielectric coated PCB and one bare PCB were placed in direct sunlight for about 3 hours. Thermocouples were coupled to each of the PCB boards. The silver colored dielectric coated PCB board was found to be at a temperature about 11° C. below the bare PCB indicating reflection of a substantial portion of the solar radiation.

### Performance During Actual Flight

Radiosonde systems according to an embodiment of the invention analogous to system 500 were tied to radiosonde balloons and released along with conventional radiosonde modules for comparison. Pressure, temperature and humidity were measured. The data obtained showed significantly better consistency between the radiosonde modules according to embodiments of the invention as compared to the conventional radiosonde modules through 18 km above sea level and a temperature as low as of −60° C. In particular, the flight test performed confirmed the ability for radiosonde systems according to embodiments of the invention to accurately measure humidity data with a single humidity sensor and without a heater to remove condensed phases.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. A radiosonde, comprising:
a plurality of different sensors for acquiring sensor data related to atmospheric data, said plurality of sensors consisting of a single humidity sensor, wherein said single humidity sensor is within a sealed housing, said sealed housing including a hydrophobic filter window that allows in ambient gases while preventing entry of condensed forms of moisture from entering said sealed housing; and
a wireless transmitter including an antenna coupled to an output of said plurality of sensors for transmission of said sensor data over a wireless path to at least one ground based receiver.

2. The radiosonde of claim 1, wherein said radiosonde is exclusive of a heater.

3. The radiosonde of claim 1, wherein said single humidity sensor comprises a capacitive sensor.

4. The radiosonde of claim 1, wherein said single humidity sensor comprises an integrated circuit capacitive sensor having an integrated temperature sensor thereon.

5. The radiosonde of claim 1, wherein said radiosonde comprises:
a controller module comprising a first printed circuit board (PCB) including a pressure sensor, a first temp sensor, and a signal conditioning and processing electronics module on said first PCB, and a housing around said controller module; and
relative humidity sensing module including a second PCB including comprising said single humidity sensor and a second temperature sensor on said second PCB, wherein said second PCB secured to said first PCB.

6. The radiosonde of claim 5, wherein said signal conditioning and processing electronics module comprises an analog to digital converter (ADC) coupled to a microcontroller coupled to receive said sensor data and output digital data, and wherein an output of said microcontroller is coupled to an input of said wireless transmitter.

7. The radiosonde of claim 6, wherein said microcontroller operates in a slave mode.

8. The radiosonde of claim 1, wherein said digital data is the form of a synchronous serial data link.

9. The radiosonde of claim 8, wherein said synchronous serial data link comprises a serial peripheral interface (SPI).

10. The radiosonde of claim 5, wherein said second PCB includes a radiation protection layer thereon.

11. The radiosonde of claim 5, wherein said pressure sensor comprises a piezoresistive sensor.

12. A radiosonde system, comprising:
a hydrogen or helium filled balloon, and
a radiosonde tethered by a rope or cord to said balloon, said radiosonde comprising:
a plurality of different sensors for acquiring sensor data related to atmospheric data, said plurality of sensors consisting of a single humidity sensor, wherein said single humidity sensor is within a sealed housing, said sealed housing including a hydrophobic filter window that allows in ambient gases while preventing entry of condensed forms of moisture from entering said sealed housing; and
a wireless transmitter including an antenna coupled to an output of said plurality of sensors for transmission of said sensor data over a wireless path to at least one ground based receiver,
wherein said radiosonde is exclusive of a heater.

13. The radiosonde system of claim 12, wherein said radiosonde is configured and secured to said rope or cord so that said hydrophobic filter window of humidity sensing system faces toward the ground.

14. The radiosonde system of claim 12, wherein said radiosonde comprises:
a controller module comprising a first printed circuit board (PCB) including a pressure sensor, a first temp sensor, and a signal conditioning and processing electronics module on said first PCB, and a housing around said controller module; and a
relative humidity sensing module including a second PCB including comprising said single humidity sensor and a second temperature sensor on said second PCB, wherein said second PCB secured to said first PCB.

15. The radiosonde system of claim 14, wherein said signal conditioning and processing electronics module comprises an analog to digital converter (ADC) coupled to a microcontroller coupled to receive said sensor data and output digital data, and wherein an output of said microcontroller is coupled to an input of said wireless transmitter.
